(19) United States
(12) Patent Application Publication
(10) Pub. No.: US 2019/0059212 A1
(43) Pub. Date: Feb. 28, 2019

(54) Broom and Rake Combination Tool

(71) Applicant: Andrew Njenga, Round Rock, TX (US)

(72) Inventor: Andrew Njenga, Round Rock, TX (US)

(21) Appl. No.: 15/692,438

(22) Filed: Aug. 31, 2017

(51) Int. Cl. A01D 11/06; A01D 7/00; A46B 15/00; A46B 5/00

(52) U.S. Cl. CPC A01D 11/06; A01D 7/00; A46B 2200/302; A46B 5/0041; A46B 15/0055

(57) ABSTRACT

A broom and rake combination tool for sweeping and raking includes first and second plates and first and second rods. The first rod is hollow and is coupled to and extends from a top of the first plate. A recess is positioned in a bottom of the first plate. A channel is positioned in the first plate and extends from the top to the recess. The second plate is complementary to the recess. The second rod is coupled to and extends from the second plate through the channel into the first rod. The second rod is slidably positionable relative to the first rod. A plurality of bristles is coupled to the first and second plates and is opposingly positioned to the first rod. A plurality of teeth is coupled to a side of the first plate. The bristles and the teeth are configured, respectively, to sweep and rake a surface.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to combination tools and more particularly pertains to a new combination tool for sweeping and raking.

### BRIEF SUMMARY OF THE INVENTION

An embodiment of the disclosure meets the needs presented above by generally comprising first and second plates and first and second rods. The first rod is hollow and is coupled to and extends from a top of the first plate. A recess is positioned in a bottom of the first plate. A channel is positioned in the first plate and extends from the top to the recess. The second plate is complementary to the recess. The second rod is coupled to and extends from the second plate through the channel into the first rod. The second rod is slidably positionable relative to the first rod. A plurality of bristles is coupled to the first and second plates and is opposingly positioned to the first rod. A plurality of teeth is coupled to a side of the first plate. The bristles and the teeth are configured, respectively, to sweep and rake a surface.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a broom and rake combination tool according to an embodiment of the disclosure.

FIG. 2 is a front view of an embodiment of the disclosure.

FIG. 3 is a side view of an embodiment of the disclosure.

FIG. 4 is a back view of an embodiment of the disclosure.

FIG. 5 is a cross-sectional view of an embodiment of the disclosure.

FIG. 6 is a bottom view of an embodiment of the disclosure.

### DETAILED DESCRIPTION OF THE INVENTION

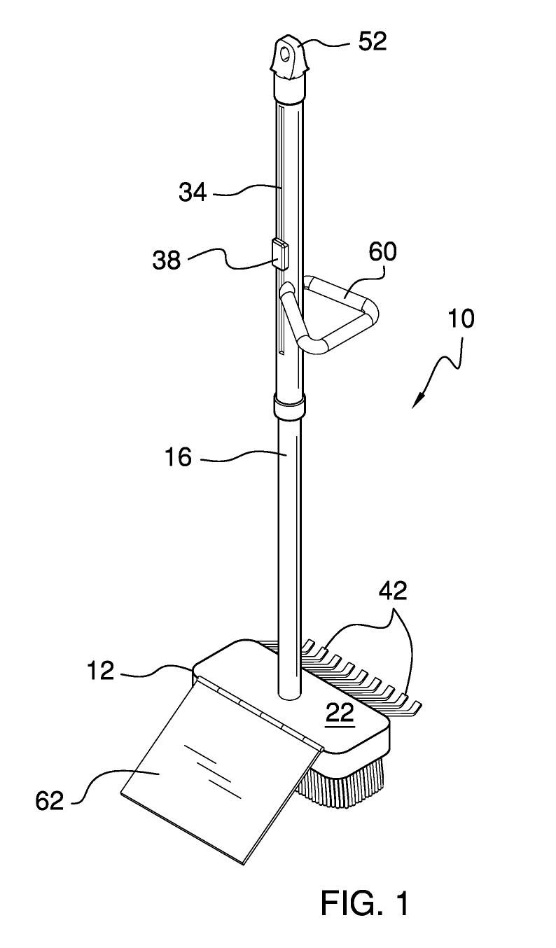

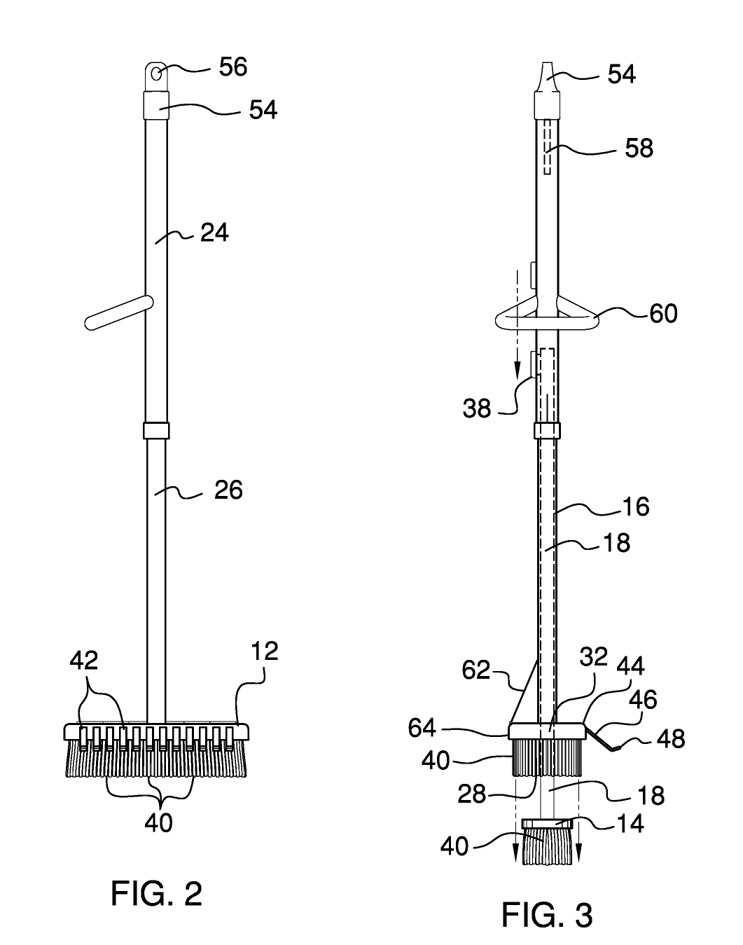

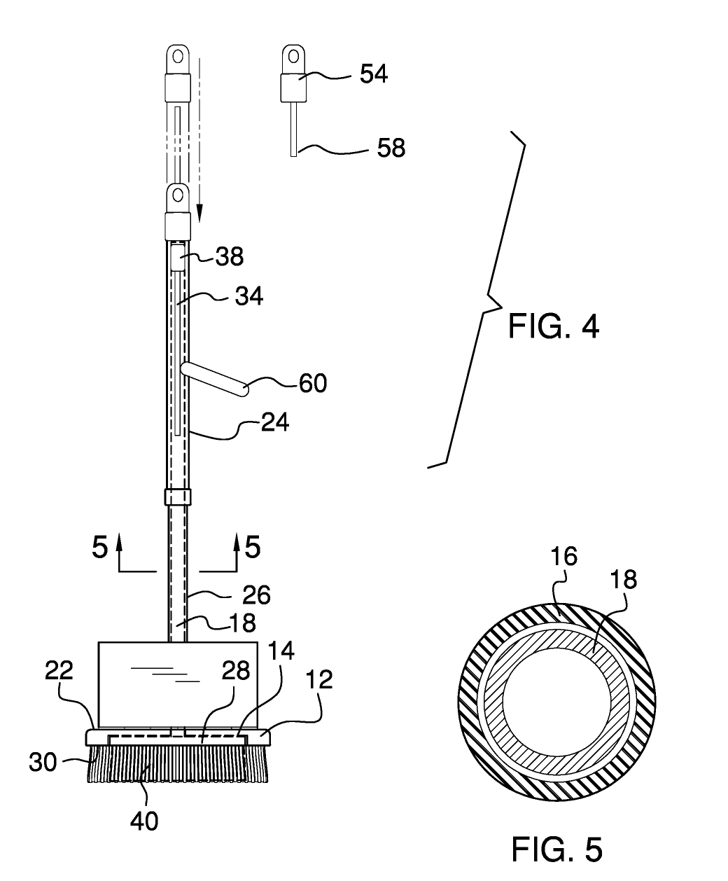

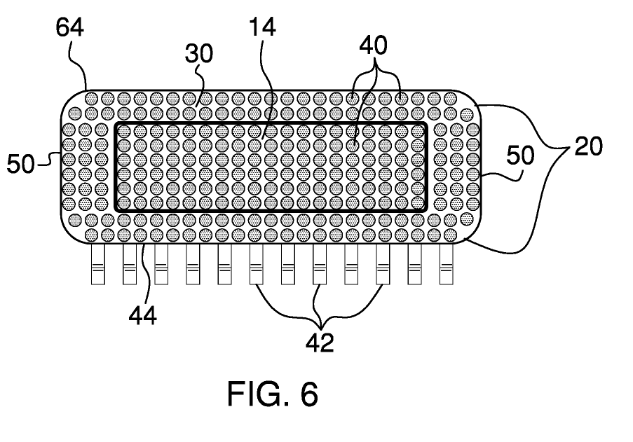

With reference now to the drawings, and in particular to FIGS. 1 through 6 thereof, a new combination tool embodying the principles and concepts of an embodiment of the disclosure and generally designated by the reference numeral 10 will be described.

As best illustrated in FIGS. 1 through 6, the broom and rake combination tool 10 generally comprises a first plate 12, a second plate 14, a first rod 16, and a second rod 18. In one embodiment, the first plate 12 is substantially rectangularly box shaped. The first plate 12 has corners 20. In another embodiment, the corners 20 are rounded.

The first rod 16 is coupled to and extends from a top 22 of the first plate 12. The first rod 16 is hollow. In one embodiment, the first rod 16 extends perpendicularly from the first plate 12. In another embodiment, the first rod 16 is circularly shaped when viewed longitudinally. In yet another embodiment, the first rod 16 comprises a top section 24 and a bottom section 26. The bottom section 26 is selectively extensible from the top section 24. The bottom section 26 is positioned in the top section 24 so that the bottom section 26 is configured to be selectively extended from the top section 24.

A recess 28 is positioned in a bottom 30 of the first plate 12. In one embodiment, the recess 28 is substantially rectangularly shaped. A channel 32 is positioned in the first plate 12. The channel 32 extends from the top 22 to the recess 28. The second plate 14 is complementary to the recess 28.

The second rod 18 is coupled to and extends from the second plate 14 through the channel 32 into the first rod 16. The second rod 18 is selectively slidably positionable relative to the first rod 16 so that the second plate 14 is selectively extensible from the first plate 12. In one embodiment, the second rod 18 is hollow.

A slot 34 is positioned longitudinally in the first rod 16 distal from the first plate 12. A first tab 36 is coupled to the second rod 18 distal from the second plate 14. The first tab 36 extends through the slot 34. A second tab 38 is coupled to and extends bidirectionally from the first tab 36 distal from the second rod 18. The second tab 38 is configured to be grasped in digits of a hand of a user. The second tab 38 is configured to be slid within the slot 34 so that the second rod 18 is selectively slidably extensible from the first rod 16.

A plurality of bristles 40 is coupled to and extends from the first plate 12 and the second plate 14. The bristles 40 are opposingly positioned relative to the first rod 16. The bristles 40 are configured to sweep a surface.

A plurality of teeth 42 is coupled to and extends from a first side 44 of the first plate 12. The teeth 42 are configured to rake the surface. In one embodiment, the teeth 42 extend from proximate to the top 22 of the first plate 12. In another embodiment, each tooth 42 comprises a first section 46 and a second section 48. The first section 46 is coupled to and extends transversely from the first plate 12 toward the bottom 30 of the first plate 12. The second section 48 is coupled to and extends transversely from the first section 46 distal from the first plate 12 and toward the top 22 of the first plate 12. In yet another embodiment, the plurality of teeth 42 extends substantially between opposing ends 50 of the first plate 12.

A connector 52 is coupled to the first rod 16 distal from the first plate 12. The connector 52 is configured to couple to a vertical surface, such as a wall, to couple the first rod 16 to the vertical surface. In one embodiment, the connector 52 comprises a cap 54 that is threadedly coupled to the first rod 16. A hole 56 is positioned through the cap 54. The hole 56 is configured to insert a coupler, such as a hook that is coupled to the vertical surface, to couple the first rod 16 to the vertical surface.

In another embodiment, a third plate 58 is coupled to the cap 54. The third plate 58 is positioned in the first rod 16 when the cap 54 is coupled to the first rod 16. The third plate 58 is selectively removable from the first rod 16 so that the third plate 58 is configured to scrap items that are adhered to the surface.

A handle 60 is coupled to and extends from the top section 24 of the first rod 16. The handle 60 is configured to be grasped in the hand of the user to facilitate motivation of the bristles 40 to sweep the surface and the teeth 42 to rake the surface.

A panel 62 is hingedly coupled to the top 22 of the first plate 12 proximate to a second side 64 of the first plate 12. The panel 62 is configured to position in an extended configuration wherein the panel 62 extends from the top 22 to the surface to support the first rod 16 in a substantially vertical position. The panel 62 also is configured to position in a stowed configuration. The panel 62 extends from the top 22 to proximate to the first rod 16 so that the bristles are configured to sweep and the teeth are configured to rake.

In use, the bottom section 26 of the first rod 16 is configured to be selectively extended from the top section 24. The bristles 40 that are positioned on the first plate 12 and the second plate 14 are configured to sweep the surface. The teeth 42 that are positioned on the first plate 12 are configured to rake the surface. The second tab 38 is configured to be grasped in the digits of the hand of the user to slide within the slot 34. The second rod 18 is slidably extensible from the first rod 16 to selectively motivate the second plate 14 distally from the first plate 12 to sweep the surface that is distal from the user. The panel 62 is configured to position in the extended configuration to support the first rod 16 in a substantially vertical position. The panel 62 also is configured to position in the stowed configuration to sweep and rake. The hole 56 that is positioned through the cap 54 is configured to insert the coupler, such as the hook that is coupled to the vertical surface, to couple the first rod 16 to the vertical surface.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A broom and rake combination tool comprising:
a first plate;
a first rod coupled to and extending from a top of said first plate, said first rod being hollow;
a recess positioned in a bottom of said first plate;
a channel positioned in said first plate, said channel extending from said top to said recess;
a second plate complementary to said recess;
a second rod coupled to and extending from said second plate through said channel into said first rod, said second rod being selectively slidably positionable relative to said first rod such that said second plate is selectively extensible from said first plate;
a plurality of bristles coupled to and extending from said first plate and said second plate, said bristles being opposingly positioned to said first rod;
a plurality of teeth coupled to and extending from a first side of said first plate; and
wherein said bristles are positioned on said first plate and said second plate such that said bristles are configured for sweeping a surface, wherein said teeth are positioned on said first plate such that said teeth are configured for raking the surface, and wherein said second rod is selectively slidably positionable relative to said first rod such that said second plate is selectively extensible from said first plate.

2. The tool of claim 1, further including said first plate being substantially rectangularly box shaped.

3. The tool of claim 2, further including said first plate having corners, said corners being rounded.

4. The tool of claim 1, further including said first rod extending perpendicularly from said first plate.

5. The tool of claim 1, further including said first rod being circularly shaped when viewed longitudinally.

6. The tool of claim 1, further including said first rod comprising a top section and a bottom section, said bottom section being selectively extensible from said top section, wherein said bottom section is positioned in said top section such that said bottom section is configured for selectively extending from said top section.

7. The tool of claim 1, further including said recess being substantially rectangularly shaped.

8. The tool of claim 1, further including said second rod being hollow.

9. The tool of claim 1, further comprising:
a slot positioned longitudinally in said first rod distal from said first plate;
a first tab coupled to said second rod distal from said second plate, said first tab extending through said slot;
a second tab coupled to and extending bidirectionally from said first tab distal from said second rod; and
wherein said second tab is positioned on said first tab such that said second tab is configured for grasping in digits of a hand of a user such that said second tab is configured for sliding within said slot such that said second rod is selectively slidably extensible from said first rod.

10. The tool of claim 1, further including said teeth extending from proximate to said top of said first plate.

11. The tool of claim 1, further including each said tooth comprising a first section and a second section, said first section being coupled to and extending transversely from said first plate toward said bottom of said first plate, said second section being coupled to and extending transversely from said first section distal from said first plate toward said top of said first plate.

12. The tool of claim 1, further including said plurality of teeth extending substantially between opposing ends of said first plate.

13. The tool of claim 1, further including a connector coupled to said first rod distal from said first plate, said connector being configured for coupling to a vertical surface, such as a wall, wherein said connector is positioned on said first rod such that said connector is configured for coupling said first rod to the vertical surface.

14. The tool of claim 13, further including said connector comprising:
a cap threadedly coupled to said first rod;
a hole positioned through said first rod; and
wherein said hole is positioned through said cap such that said hole is configured for inserting a coupler, such as a hook coupled to the vertical surface, for coupling said first rod to the vertical surface.

15. The tool of claim 14, further including a third plate coupled to said cap, said third plate being positioned in said first rod when said cap is coupled to said first rod, said third plate being selectively removable from said first rod such that said third plate is configured to scrap items adhered to the surface.

16. The tool of claim 6, further including a handle coupled to and extending from said top section of said first rod, wherein said handle is positioned on said first rod such that said handle is configured for grasping in a hand of a user for facilitating motivation of said bristles for sweeping the surface and said teeth for raking the surface.

17. The tool of claim 6, further including a panel hingedly coupled to said top of said first plate proximate to a second side of said first plate, said panel being configured for positioning in an extended configuration wherein said panel extends from said top to the surface to support said first rod in a substantially vertical position, said panel being configured for positioning in a stowed configuration wherein said panel extends from said top to proximate to said first rod such that said bristles are configured for sweeping and said teeth are configured for raking.

18. A broom and rake combination tool comprising:
a first plate, said first plate being substantially rectangularly box shaped, said first plate having corners, said corners being rounded;
a first rod coupled to and extending from a top of said first plate, said first rod being hollow, said first rod extending perpendicularly from said first plate, said first rod being circularly shaped when viewed longitudinally, said first rod comprising a top section and a bottom section, said bottom section being selectively extensible from said top section, wherein said bottom section is positioned in said top section such that said bottom section is configured for selectively extending from said top section;
a recess positioned in a bottom of said first plate, said recess being substantially rectangularly shaped;
a channel positioned in said first plate, said channel extending from said top to said recess;
a second plate complementary to said recess;
a second rod coupled to and extending from said second plate through said channel into said first rod, said second rod being selectively slidably positionable relative to said first rod such that said second plate is selectively extensible from said first plate, said second rod being hollow;
a slot positioned longitudinally in said first rod distal from said first plate;
a first tab coupled to said second rod distal from said second plate, said first tab extending through said slot;
a second tab coupled to and extending bidirectionally from said first tab distal from said second rod, wherein said second tab is positioned on said first tab such that said second tab is configured for grasping in digits of a hand of a user such that said second tab is configured for sliding within said slot such that said second rod is selectively slidably extensible from said first rod;
a plurality of bristles coupled to and extending from said first plate and said second plate, said bristles being opposingly positioned to said first rod, wherein said bristles are positioned on said first plate and said second plate such that said bristles are configured for sweeping a surface;
a plurality of teeth coupled to and extending from a first side of said first plate, wherein said teeth are positioned on said first plate such that said teeth are configured for raking the surface, said teeth extending from proximate to said top of said first plate, each said tooth comprising a first section and a second section, said first section being coupled to and extending transversely from said first plate toward said bottom of said first plate, said second section being coupled to and extending transversely from said first section distal from said first plate toward said top of said first plate, said plurality of teeth extending substantially between opposing ends of said first plate;
a connector coupled to said first rod distal from said first plate, said connector being configured for coupling to a vertical surface, such as a wall, wherein said connector is positioned on said first rod such that said connector is configured for coupling said first rod to the vertical surface, said connector comprising:
a cap threadedly coupled to said first rod,
a hole positioned through said first rod, and
wherein said hole is positioned through said cap such that said hole is configured for inserting a coupler, such as a hook coupled to the vertical surface, for coupling said first rod to the vertical surface;
a third plate coupled to said cap, said third plate being positioned in said first rod when said cap is coupled to said first rod, said third plate being selectively removable from said first rod such that said third plate is configured to scrap items adhered to the surface;
a handle coupled to and extending from said top section of said first rod, wherein said handle is positioned on said first rod such that said handle is configured for grasping in a hand of a user for facilitating motivation of said bristles for sweeping the surface and said teeth for raking the surface;
a panel hingedly coupled to said top of said first plate proximate to a second side of said first plate, said panel being configured for positioning in an extended configuration wherein said panel extends from said top to the surface to support said first rod in a substantially vertical position, said panel being configured for positioning in a stowed configuration wherein said panel extends from said top to proximate to said first rod such that said bristles are configured for sweeping and said teeth are configured for raking; and
wherein said bottom section of said first rod is positioned in said top section such that said bottom section is configured for selectively extending from said top section, wherein said bristles are positioned on said first plate and said second plate such that said bristles are configured for sweeping the surface, wherein said teeth are positioned on said first plate such that said teeth are configured for raking the surface, wherein said second tab is positioned on said first tab such that said second tab is configured for grasping in the digits of the hand of the user such that said second tab is configured for sliding within said slot such that said second rod is selectively slidably extensible from said first rod for selectively motivating said second plate distally from said first plate for sweeping a surface distal from the user, wherein said hole is positioned through said first rod such that said hole is configured for inserting the coupler, such as the hook coupled to the vertical surface, for coupling said first rod to the vertical surface.
